(19) United States
(12) Patent Application Publication
(10) Pub. No.: US 2015/0002657 A1
(43) Pub. Date: Jan. 1, 2015

(54) METHOD AND APPARATUS FOR USING VEHICLE CAMERAS TO CAPTURE AND SHARE DIGITAL MEDIA

(71) Applicant: Ford Global Technologies, LLC, Dearborn, MI (US)

(72) Inventor: Jamal Alezzani, Dearborn, MI (US)

(21) Appl. No.: 13/927,481

(22) Filed: Jun. 26, 2013

(51) Int. Cl. H04L 29/08; B60R 1/00; B60R 11/04

(52) U.S. Cl. CPC H04L 67/12; B60R 11/04; B60R 1/002
USPC 348/118; 348/148

(57) ABSTRACT

A method includes capturing digital media using at least one camera that is attached to an outer perimeter of a vehicle, uploading the digital media to a social media site, and tagging the digital media with at least one feature that corresponds to an individual that captured the digital media.

### BACKGROUND

It is commonplace for digital photographs and other digital media (e.g., audio, text, and video as examples) to be uploaded to social media on the internet using a cell phone. The cell phone may have WiFi capability for interacting with and browsing the internet, or the cell phone may have direct wireless access to the internet via a network provider. Typically digital media is uploaded using an Application Program Interface (API) or other electronic means (such as texting) that is executed on the cell phone. The image is transmitted, along perhaps with personalized commentary related to the image and/or global positioning system (GPS) location information, for sharing with other users of the social media to which the image is uploaded.

Drivers often encounter interesting or humorous events or scenes that they desire to capture and upload to social media, along with commentary. However, operating a cell phone to capture and upload an image while driving can be dangerous or even illegal in some jurisdictions.

Thus, there is a need for a safe and convenient way of capturing and uploading images from a vehicle to social media sites.

### SUMMARY

A method includes capturing digital media using at least one camera that is attached to an outer perimeter of a vehicle, uploading the digital media to a social media site, and tagging the digital media with at least one feature that corresponds to an individual that captured the digital media.

A non-transitory computer-readable medium tangibly embodying computer-executable instructions comprising steps to capture an image using at least one digital device that is attached to a perimeter of a vehicle, upload the image to a social media site, and tag the digital media with at least one feature that corresponds to an individual that captured the digital media.

A host vehicle includes a camera configured to capture digital media using at least one camera that is attached to an outside of the vehicle, and a communication module configured to capture digital media using at least one camera that is attached to a vehicle, upload the digital media to a social media site via a computing device, and tag the digital media, using the computing device, with at least one feature that corresponds to an individual that captured the digital media.

### BRIEF DESCRIPTION OF THE DRAWINGS

FIG. 1 illustrates a plan view of a host vehicle proximate front and rear cars that define a parking space for parking assist;

FIG. 2 illustrates elements of a host vehicle for parking assist;

FIG. 3 illustrates a flowchart of a method for parking a vehicle; and

FIG. 4 illustrates a process or method of interacting with the internet using at least one camera that is coupled to a vehicle.

### DETAILED DESCRIPTION

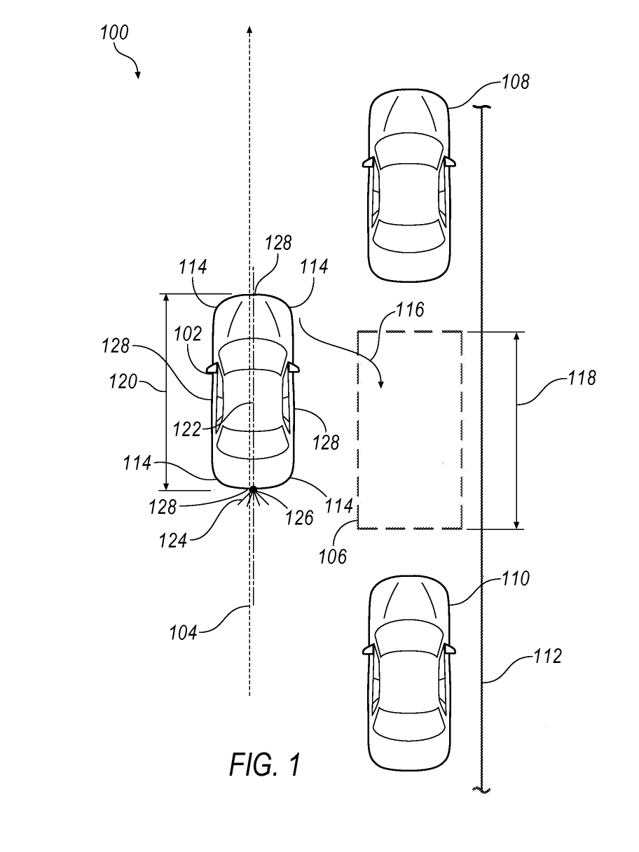

FIG. 1 shows a parking assist scenario 100 in which a running or host vehicle 102, such as a car, may employ a park assist system for assisting or instructing a driver in what actions to take to park the vehicle, such as when parallel parking. As host vehicle 102 passes along a path 104, a parking space 106 is identified by the park assist system as located between two parked vehicles 108 and 110. Parking space is thus defined between vehicles 108, 110, and is also defined by a constraint on the far side, such as a curb 112. Parking space 106 may be defined or bounded by any type or number or objects or constraints, not necessarily vehicles 108, 110 and curb 112.

As will be further illustrated, an exemplary vehicle may include a number of cameras attached to the outside of the vehicle and positioned to obtain digital photographs of the surrounding area to assess potential parking spots, identify obstructions, and provide input to a control module to guide the vehicle into an identified parking spot. In some exemplary approaches, cameras attached to the outside of the vehicle, e.g., on bumpers, external sheet metal, or other vehicle structures, may also be used to provide a park assistance feature to a vehicle operator. In one example, the camera is part of a lane departure warning system having cameras mounted as described in the above embodiments, and/or as a camera mounted on a windshield of a car. In such approaches, in addition to supporting a park assist operation by providing information on vehicle surroundings, one or more of the cameras may be used to obtain digital photographs or a video image, as examples of digital media, from one or more of the cameras. The digital media may be obtained in a hands-free operation as one example, which can be captured, uploaded to a social media site, and tagged to identify the digital media. As will be further illustrated, the operations such as capturing the digital media, uploading, and tagging may be performed using a communication module that is controlled by a smart phone (and the steps are performed in the communication module itself), or the communication module may simply serve as an intermediary and all steps can be performed using the smart phone itself

As such, cameras positioned on a vehicle that are typically used for a park assist operation may additionally be used to interact, directly or indirectly, with a social media site. That is, by further linking the cameras to a communication module, additional capabilities may be introduced by taking advantage of the use of cameras that are already there for the purposes of park assist.

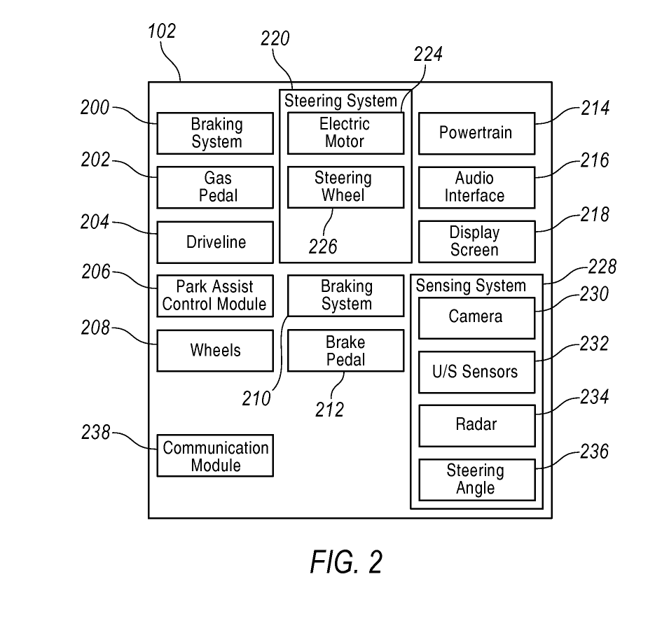

Referring to FIG. 2, host vehicle 102 includes a braking system 200, a gas pedal 202, a driveline 204, a park assist control module (PACM) 206, and wheels 208. Vehicle 102 also includes a braking system 210, a brake pedal 212, a powertrain 214, an audio interface 216, and a display screen 218. A steering system 220 is shown in an example to include an electric motor 224 and a steering wheel 226. Steering system 220 may be used in a power assisted steering system, or steering system 220 may include any type of steering system such as a conventional vacuum/hydraulic system, an electro-hydraulic power assisted system (EHPAS), or a ‘steer-by-wire’ system. Host vehicle 102 may include an accelerometer that measures an acceleration of vehicle 102.

In the illustrated embodiment, a sensing system 228 is operatively connected to vehicle 102 and may be coupled to PACM 206 to provide input signal(s) thereto. Sensing system 228 includes sensors for sensing the vehicle environment, such as a camera 230 (which will be further described as rear, front, and/or side cameras), ultrasonic (U/S) sensors 232 (which may include a transmitter and sensor), radar 234, and a steering sensor 236, as examples. Sensing system 228 includes systems that include but are not limited to LIDAR, thermal sensors, and a global positioning system (GPS). As shown in FIG. 1, four sensors 114, such as ultrasonic sensors, may be located on the left and right sides of vehicle 102 adjacent front and rear bumpers to provide full or near-full 360° coverage around vehicle 102. The number, type, and/or the location of the sensors may be other than illustrated if so desired.

Sensing system 228 may include sensors for detecting the status or mode of operation of various systems on-board the vehicle 102, such as an odometer sensor (not shown) and/or steering wheel angle sensor 236. The odometer sensors may be located on one or more of wheels 226 of vehicle 102 and/or in the driveline system 204 of vehicle 102. Steering wheel angle sensor 236 is associated with steering system 220 of vehicle 102 and may, for example, be located on steering wheel 226 or on a steering column, as an example. Vehicle 102 may also be equipped with video display screen 218 for the display of various types of information to the driver. Vehicle 102 may also include audio interface device 216 such as a speaker, chime, buzzer, or other device for generating sound.

Vehicle 102 includes a communication module 238 that is in communication with other elements of vehicle 102, such as camera(s) 230, U/S sensors 232, radar 234, audio interface 216, sensing system 228 in general, and the like. Communication module 238 in one example is hard-wired to one or more of the elements of vehicle 102, and in another example is wirelessly connected thereto, wherein communication is via a known protocol such as BLUETOOTH or ZigBee, as examples. Communication module 238 may also be configured to communicate with a cell phone that is carried, for instance, by a driver or passenger positioned within vehicle 102. In one example, communication module 238 includes an audio input to capture audio content from a microphone that is positioned within the vehicle. In such fashion, a driver and/or a passenger within vehicle 102 may communicate verbally with communication module 238 to command various tasks using, for instance, voice-recognition.

Communication module 238 may be controlled via operations within vehicle 102, such as with display screen 218 (which, in one embodiment, is touchscreen activated and controlled). In addition or in the alternative, communication module 238 may be controlled via an Application Program Interface (API) that may be executed on a cell phone, such as a smartphone. In one example, communication module 238 is also configured to wirelessly interact with the internet via either WiFi or via a cellphone carrier, as examples. As such and in general, communication module 238 is configured to interact with sensors, cameras, etc. of vehicle 102, and also configured to interact with a smartphone and/or directly to the internet.

As shown in FIG. 1, vehicle 102 is parked into parking space 106 using PACM 206. To accomplish this, at least one of sensors 114 is used to detect neighboring objects and their location relative to the position of the vehicle 102 as vehicle 102 travels along path 104 and passes objects 110, 108. In FIG. 1, the neighboring objects that define parking space 106 are shown as being the two parked vehicles 110, 108 and curb 112. It is contemplated that PACM 206 may successfully identify a parking space 106 relative to only one object or vehicle, such as either the vehicle 108 or vehicle 110, if present.

PACM 206 includes a data processing component that processes the information from the sensor(s) to evaluate whether vehicle 102 may be successfully parked in parking space 106. The data processing component may, for example, be a micro-computer based device, as is well known. Evaluation by PACM 206 may involve determining if a valid steering trajectory 116 can be performed to park vehicle 102 in parking space 106. If a valid steering trajectory 116 exists, PACM 206 deems parking space 106 to be a feasible parking space. The calculations performed by PACM 206 may include a determination of a proper slot length 118 depending upon considerations such as a length 120 of vehicle 102, and/or an achievable turning radius of vehicle 102, and/or any other geometric considerations related to vehicle 102 and/or other objects in the vicinity of parking space 106.

Movement of vehicle 102 along steering trajectory 116 may be performed in one or more parking maneuvers as may be necessary until it is properly parked. As used herein, one parking maneuver is defined as (1) moving the vehicle rearwardly from a stop into the parking space, (2) stopping the vehicle briefly within the parking space, (3) moving the vehicle forward within the parking space, and (4) then stopping and thus parking the vehicle. At least one actuation or movement of steering system 220 is usually required in association with each of the steps in the parking maneuver to achieve trajectory 116. A subsequent rearward and/or forward movement of vehicle 102, as may be necessary if parking space 106 is too short relative to vehicle length 120 and/or turning radius, defines an additional parking maneuver.

Once it is determined that vehicle 102 is properly parked in a desired parked condition, PACM 206 operates steering system 220 to return it to a centered condition. In one example, this involves actuating electric motor 224 to move steering wheel 226 and associated components of steering system 220 so that the steerable road wheels of vehicle 102 are aligned parallel with a longitudinal (front-to-rear) axis 122 of vehicle 102.

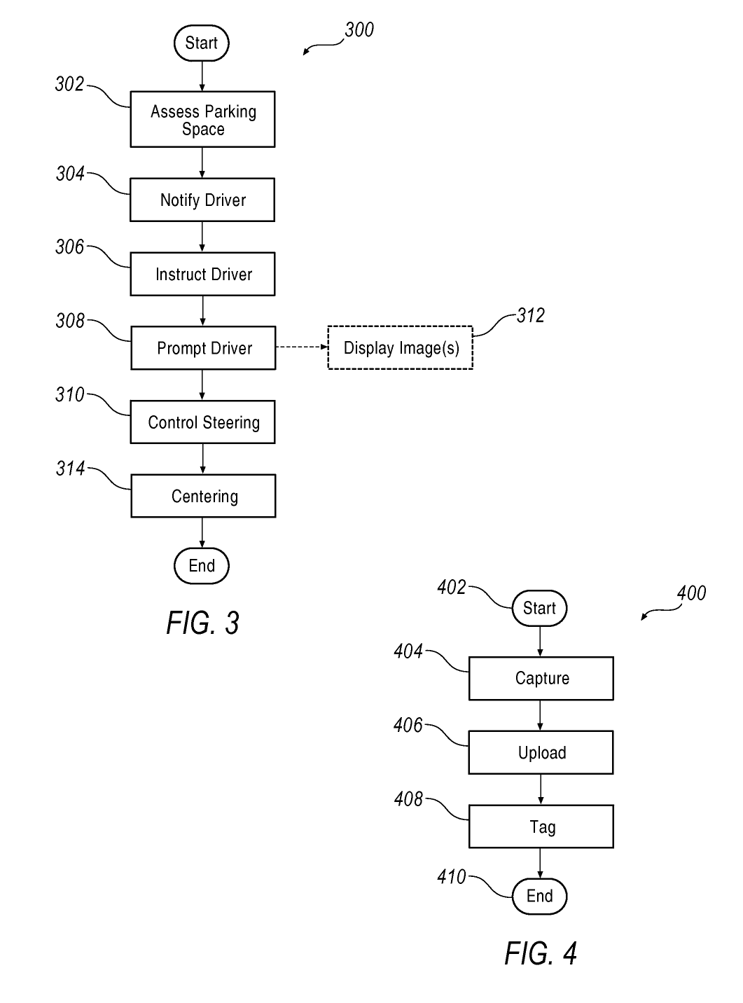

Referring to FIG. 3, a flow chart 300 shows a method for parking a vehicle using park assist. At first step 302, a processing module, such as PACM 206, determines if there is a feasible parking space available for parking of vehicle 102. This may be accomplished, for example, using signals from sensor(s) 114 of sensing system 228. A feasible parking space is one, such as parking space 106, that is sufficiently large for vehicle 102 to fit into using the park assist system with which it is equipped.

If the parking space is determined at step 302 to be feasible for parking, the driver is notified or alerted at step 304 that a feasible parking space is available. The notification may be delivered via a visual and/or audible signal interface to, for instance, display screen 218 within vehicle 102. Alternatively, the visual interface may be a graphic image, icon, or other non-text representation on display screen 218. Such a visual interface may be located at any appropriate location in vehicle 102, such as an overhead console. Audible signals may be via audio interface 216, as another example.

Next, at step 306, the driver is instructed to stop the vehicle and to accept the system assistance to park. This instruction may be delivered visually and/or audibly, and may be accomplished by the same interface(s) used in step 304. Once the driver has stopped vehicle 102, at step 308 the driver is prompted to remove hands from the steering control device of the steering system (steering wheel 226, for example) and to actuate a brake control device (such as brake pedal 212) and a transmission control device (such as a gear select lever or button) to engage or shift the transmission of powertrain system 214 into reverse gear.

At step 310, the park assist system takes over control of steering system 224 to execute steering trajectory 116. In one example, the park assist system generates signals to prompt the driver to take actions necessary to drive the vehicle backwards and pull forward (in one or more parking maneuvers) to achieve a parked condition of vehicle 102 in parking space 106. The parked condition may be defined, depending upon the nature and dimensions of the parking space, as when vehicle 102 is within a certain distance of one or more of the objects or features that define the space and/or within a certain angular measure of being parallel with the appropriate objects/features.

Driver actions prompted at step 308 may include actions such as actuating brake pedal 212 of braking system 210 to control the speed of the vehicle and/or actuating a transmission control device to engage or shift the transmission of the powertrain system 214 between forward and reverse gears.

As indicated at step 312, the method may optionally include displaying to the driver an image of the parking space environment. For example, an image 124 from a rear view camera 126 may be displayed on a video display screen. In another example, a simulated or virtual top view showing the vehicle and its location relative to the parking space may be displayed on display screen 218. Either of these images may be overlaid with lines and/or other symbols depicting the desired steering trajectory 116. In one embodiment, additional cameras 128 may be included in the front, and/or rear, and/or sides of vehicle 102. As such, rear camera 126 and front and side cameras 128 may be employed for obtaining front, side, and back images to support the park assist system. Typically and as shown, cameras 126 and 128 are attached generally to an outer perimeter of the vehicle and are thus well positioned to obtain photographs or video of the area surrounding the vehicle to not only provide images for park assist, but additionally to obtain images of the area for uploading to the internet. That is, often a driver is in an area where a pretty sunset, interesting architecture, and the like, are viewed by the driver. To avoid dangerous maneuvers by using a camera or smartphone, the images may be obtained using the park assist cameras, thereby adding additional functionality to the cameras by use of a communication module.

When the park assist system has determined that vehicle 102 is properly parked and the final movement of the parking maneuver is complete, the method progresses to step 314 where steering system 220 is operated to place it in a centered condition between surrounding objects such as vehicles 108, 110, or generally in line with curb 112 and/or path 104. This may involve actuating electric motor 224 that provides power boost to the steering system so as to move steering wheel 226 along with associated components of steering system 220 until vehicle 102 wheels are parallel with axis 122 of vehicle 102.

Although the parking space 106 has been described as a parallel parking space between a forward first object and a rearward second object, the parking space may alternatively be a rear perpendicular parking space, such as found in typical multi-vehicle parking lots and garages. Additionally, parking space 106 has been described as being on the right side of the vehicle 102, but alternatively the park assist system may be used to identify a parking space on the left side of vehicle 102.

As such, park assist systems typically include cameras 126, 128 that are coupled or mounted to vehicle 102 to obtain images front, rear, and to the sides of vehicle 102, and cameras 126, 128 are accessible via communication module 238.

However and as stated, because the park assist typically includes the use of a multitude of cameras positioned about the perimeter of the vehicle, such cameras may be made available to a communication module, such as communication module 238, to add a further capability and take advantage of the presence of the cameras on the vehicle. Digital media may be obtained using the cameras in a hands-free operation as one example, which can be captured, uploaded to a social media site, and tagged to identify the digital media. Thus, the method illustrated in FIG. 3 may be elaborated to take advantage of the presence of cameras 126, 128 as follows.

Referring to FIG. 4, a process or method 400 of interacting with the internet is disclosed. Starting at step 402, at step 404 digital media is captured that includes using at least one camera that is coupled to a vehicle. The digital media captured includes a digital photograph and/or a video file, or a livestream of video, as examples. That is, a host vehicle such as vehicle 102 captures the digital media using cameras, such as cameras 126, 128, that are attached or otherwise coupled to vehicle 102. That is, the camera(s) used for obtaining the digital media may include one of a front, back, and side camera of the vehicle. As stated, typically the camera(s) are useable for a park assist operation as described.

At step 406, the captured digital media is uploaded to a social media site via a computing device. The term “uploading” generally refers to any method of moving digital media to the internet. In one example, uploading refers to one or more static digital photographs or scans of an image. In another example, uploading refers to a digital video that is uploaded in its entirety. However, in yet another example uploading refers to a continuous or livestream of video content from one or more of cameras 126 and/or 128 that is viewable in real-time, and may also be recorded for posterity and for additional viewing later and after the real-time event. In one example, the uploaded digital media is a static photograph of a compilation from cameras 126, 128 that includes a full panoramic view of the region surrounding the vehicle (could be a 180° view or a full 360° view, as examples).

The step of capturing the digital media may also include, in one embodiment, analyzing the digital media and manipulating the digital media to enhance its presentation. For instance, a digital photograph may be retouched to convert it to black and white, to enhance certain colors, or to change the visible lighting appearance, as examples.

Social media sites are ever-changing in nature and thus, for the sake of this disclosure, broadly encompass any internet-based communication service to which digital media may be uploaded and viewed by others. The digital media may be viewed by the general public, in one example, or may be viewed by a limited number of people, the list of which may be controlled or controllable by the social media site, the user who uploads the digital media, or by others. Social media sites may include but are not limited to Facebook®, Twitter®, Instagram®, Pinterest®, and the like.

In addition, at step 408, the digital media may be tagged to include at least one feature that corresponds to an individual or the user that captured the digital media. The features for tagging the digital media may include a time stamp, date stamp, or a text caption that corresponds to the uploaded digital media. For instance, the user may add a caption that addresses the rainy weather or addresses a certain feature visible within the digital media. In one embodiment, the user may “tag” one or more individuals within the digital media, such as identifying one or more people within the image itself and identifying them as a certain person or persons. Other elements may be tagged without limit of the types of tags as well, such as an automobile, a statue, or a building. In one embodiment, location information is attached to the digital media that is obtained via a GPS, wherein the GPS is contained in one of the cell phone and the communication module. Method 400 ends at step 410.

As stated, vehicle 102 includes communication module 238. Communication module 238 may communicate with a cell phone, and/or may wirelessly interact directly with the internet. Thus, in one example the steps illustrated in FIG. 4 and as summarized above are performed using module 238 itself to capture digital media using at least one camera that is attached to a vehicle, upload the digital media to a social media site via a computing device, and tag the digital media, using the computing device, with at least one feature that corresponds to an individual that captured the digital media.

The steps of capturing, uploading, and tagging, in one example, are performed using a hands-free operation. Thus, the audio input to communication module 238 may include commands that are recognizable such that the digital media can be manipulated without the user having to activate buttons or a touchscreen to command the various operations. Thus, in one example, the steps of capturing, uploading, and tagging are performed using communication module 238 of the vehicle. In another example, communication module 238 serves as a vehicle for capturing, manipulating, and tagging the digital vehicle. However, in this example, the commands for doing so are controlled via an API that is executed on a handheld device such as a cellphone or smartphone, as examples.

In addition, method or process 400 may be implemented on a non-transitory computer-readable medium tangibly embodying computer-executable instructions comprising steps to capture an image using at least one digital device that is coupled to a vehicle, upload the image to a social media site, and tag the digital media with at least one feature that corresponds to an individual that captured the digital media. Additional steps as described can be implemented on the non-transitory computer-readable medium, as well.

An implementation of the embodiments of the invention in an example employs one or more computer readable storage media. In general, computing systems and/or devices, such as the processor and the user input device, may employ any of a number of computer operating systems, including, but by no means limited to, versions and/or varieties of the Microsoft Windows® operating system, the Unix operating system (e.g., the Solaris® operating system distributed by Oracle Corporation of Redwood Shores, Calif.), the AIX UNIX operating system distributed by International Business Machines of Armonk, New York, the Linux operating system, the Mac OS X and iOS operating systems distributed by Apple Inc. of Cupertino, California, and the Android operating system developed by the Open Handset Alliance.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. A method, comprising:
capturing digital media using at least one camera that is attached to an outer perimeter to a vehicle;
uploading the digital media to a social media site; and
tagging the digital media with at least one feature that corresponds to an individual that captured the digital media.

2. The method of claim 1, wherein the digital media comprises one of a digital photographs, a video file, and a livestream of video.

3. The method of claim 1, further comprising adding a text caption that corresponds to the uploaded digital media.

4. The method of claim 1, wherein at least one of the steps of capturing the digital media, uploading the digital media, and tagging the digital media is performed in a voice-activated mode.

5. The method of claim 1, further comprising controlling the steps of capturing, uploading, and tagging using a cellphone.

6. The method of claim 1, further comprising controlling the steps of capturing, uploading, and tagging using a communication module of the vehicle.

7. The method of claim 1, further comprising attaching location information to the uploaded digital media that is obtained via a global positioning system (GPS), wherein the GPS is contained in one of a cell phone and a communication module.

8. The method of claim 1, wherein the at least one camera is on one of a front, back, and side of the vehicle, and wherein the at least one camera is useable for a park assist operation.

9. A non-transitory computer-readable medium tangibly embodying computer-executable instructions comprising steps to:
capture an image using at least one digital device that is attached to a perimeter of a vehicle;
upload the image to a social media site; and
tag the digital media with at least one feature that corresponds to an individual that captured the digital media.

10. The computer-readable medium of claim 9, wherein the image is one of a digital photograph, an image within a moving video file, and an image within a livestream of video.

11. The computer-readable medium of claim 9, wherein the at least one feature is a username.

12. The computer-readable medium of claim 9, wherein the computer-executable instructions include steps to add a text caption that corresponds to the uploaded digital media.

13. The computer-readable medium of claim 9, further comprising wherein the computer-executable instructions are embodied in one of a cellphone and a communication module of the vehicle.

14. The computer-readable medium of claim 9, wherein the computer-executable instructions include steps to attach location information to the uploaded digital media, wherein the location information is obtained via a global positioning system (GPS), and wherein the GPS is contained in one of the cell phone and the communication module.

15. A host vehicle comprising:
a camera configured to capture digital media using at least one camera that is attached to an outside of the vehicle; and
a communication module configured to:
capture digital media using at least one camera that is attached to a vehicle;
upload the digital media to a social media site via a computing device; and
tag the digital media, using the computing device, with at least one feature that corresponds to an individual that captured the digital media.

16. The vehicle of claim 15, wherein the computing device is configured to add a text caption that corresponds to the uploaded digital media.

17. The vehicle of claim 15, wherein the computing device is configured to perform at least one of the steps to capture the digital media, upload the digital media, and tag the digital media, and is performed in a voice-activated mode.

18. The vehicle of claim 15, wherein the communication module is further configured to interface with a cellphone, wherein the cellphone is configured to capture, upload, and tag the digital media.

19. The vehicle of claim 15, wherein the communication module is further configured to capture, upload, and tag the digital media.

20. The vehicle of claim 15, wherein the at least one camera is on one of a front, back, and side of the host vehicle, and wherein the at least one camera is useable for a park assist operation that is executable by the control module.
